(19) United States
(12) Patent Application Publication
(10) Pub. No.: US 2008/0148353 A1
(43) Pub. Date: Jun. 19, 2008

(54) INFORMATION PROCESSING APPARATUS, SYSTEM, PROGRAM, DEVICE, AND STORAGE MEDIUM

(75) Inventor: Makoto Dohi, Chigasaki-shi (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 11/955,884

(22) Filed: Dec. 13, 2007

(30) Foreign Application Priority Data
Dec. 15, 2006 (JP) 2006-339068

(51) Int. Cl. G06F 21/22

(52) U.S. Cl. 726/2

(57) ABSTRACT

An information processing apparatus capable of updating secret information for use by device each time the apparatus is connected to a device which is the same as or different from one to which the apparatus was connected last time, thereby suppressing the secret information being leaked or unauthorizedly used. When it is determined that device IDs stored in a device ID temporal storage unit and a device ID storage section do not coincide with each other, a network print server newly generates and stores another secret information including a secret key and a public key, and transfers the public key and the secret key to a server computer and a printer controller, respectively. Using the public key acquired from the computer, the client computer encrypts print data and transfers the encrypted data to a printer. Using the secret key acquired from the server, the printer controller decrypts the encrypted print data and executes printing.

### BACKGROUND OF THE INVENTION

1. Field of the Invention

The present invention relates to an information processing apparatus such as an expansion card adapted to be connected (or mounted) to an expansion slot or the like of a printer or some other device to achieve a predetermined function such as an expansion function, and relates to a system, a program, a device, and a storage medium in or with which the information processing apparatus is used.

2. Description of the Related Art

Conventionally, an information processing apparatus such as an expansion card has been known, which is removably connected to a device such as a printer and through which the device is connected to a network. The information processing apparatus and the device have license codes stored therein. Furthermore, the information processing apparatus stores an application for expansion of the function of the device. Upon start of the application, the information processing apparatus compares the license code stored therein with the license code stored in the device, and starts the application only when these license codes match each other. Even when the information processing apparatus disconnected from the device is connected to another device, therefore, the application stored in the information processing apparatus is prevented from being used by the other device (see, Japanese Laid-open Patent Publication No. 2005-038009).

A printer as the device receives, for example, encrypted data from an external apparatus such as a client computer, and decrypts the received data using decryption information (such as for example, a secret key), whereby the data received from the external apparatus can be printed.

In that case, in order to transfer data to the printer, the client computer encrypts the data using a public key corresponding to the secret key. The public key is saved beforehand in an authentication server, for example. The client computer wishing to transfer the encrypted data to the printer acquires the public key from the authentication server, and then encrypts the data using the public key.

As a result, there hardly occur problems such that print data is secretly looked at while being transferred along a transfer path (such as a network) between the client computer and the printer or erroneously transferred to an unintended printer to be printed there.

In a system including a device connected with an information processing apparatus capable of providing various functions without the need of changing the firmware of the device, it is preferable that information proper to the information processing apparatus should not be stored in the device but in the information processing apparatus.

On the other hand, in a case where information such as a secret key (hereinafter referred to as the “secret information”) is stored in the information processing apparatus, the secret information is copied, for use by a first device, from the information processing apparatus into nonvolatile storage means of the first device. This is, for example, a case where the information processing apparatus is connected to the first device for use by the first device. When the information processing apparatus disconnected from the first device is connected to a second device, if the secret information is copied, for use by the second device, from the information processing apparatus into a nonvolatile storage means in the second device, the same secret information can be used by both the first and second devices.

In that case, there is a fear that the secret information is leaked and unauthorizedly used. For example, when secret information prepared for use by the first device is leaked to the second device, data which the client computer is intended to send to the first device can be printed even by the unintended second device. Conversely, when the information processing apparatus disconnected from the first device is connected to the second device, the secret information to be subsequently used by the second device still remains in the first device, and data intended to be sent to the second device can be printed even by the first device.

### SUMMARY OF THE INVENTION

The present invention provides an information processing apparatus capable of updating secret information for use by device each time the information processing apparatus is connected to a device which is the same as or different from one connected with the apparatus last time, thereby suppressing the secret information from being leaked and unauthorizedly used, and provides a system, a program, a device, and a storage medium, in or with which the information processing apparatus is used.

According to a first aspect of this invention, there is provided an information processing apparatus adapted to be connected to a device, comprising a storage unit adapted to store secret information, a secret information generation unit adapted to generate another secret information when the information processing apparatus is connected to the device, a secret information update unit adapted to update the secret information stored in the storage unit to the other secret information generated by the secret information generation unit in a case where the secret information is generated by the secret information generation unit, and a secret information transfer unit adapted to transfer the other secret information updated by the secret information update unit and stored in the storage unit to the device to which the information processing apparatus is connected.

According to a second aspect of this invention, there is provided a device to which the information processing apparatus of the first aspect of this invention is connected, comprising a secret information acquisition unit adapted to acquire the other secret information transferred from the secret information transfer unit of the connected information processing apparatus, and a processing unit adapted to decode received data using the other secret information acquired by the secret information acquisition unit.

According to a third aspect of this invention, there is provided an information processing system including a plurality of devices and an information processing apparatus adapted to be connected to an arbitrary one of the plurality of devices, wherein the information processing apparatus comprises a storage unit adapted to store secret information, a secret information generation unit adapted to generate another secret information when the information processing apparatus is connected to the device, a secret information update unit adapted to update the secret information stored in the storage unit to the other secret information generated by the secret information generation unit in case where the secret information is generated by the secret information generation unit, and a secret information transfer unit adapted to transfer the other secret information updated by the secret information update unit and stored in the storage unit to the device to which the information processing apparatus is connected, and wherein each of the plurality of devices comprises a secret information acquisition unit adapted to acquire the other secret information transferred from the secret information transfer unit, and a processing unit adapted to decode received data using the other secret information acquired by the secret information acquisition unit.

According to a fourth aspect of this invention, there is provided an information processing program that causes a computer to execute an information processing method in an information processing apparatus including a storage unit adapted to store secret information, the information processing method comprising a secret information generation step of generating another secret information, with the information processing apparatus connected to a device, a secret information update step of updating the secret information stored in the storage unit to the other secret information generated in the secret information generation step in case where the other secret information is generated in the secret information generation step, and a secret information transfer step of transferring the other secret information updated in the secret information update step and stored in the storage unit to the device to which the information processing apparatus is connected.

According to a fifth aspect of this invention, there is provided a storage medium in which the information processing program of the fourth aspect of this invention is computer-readably stored.

The present invention can suppress secret information from being leaked or unauthorizedly used by updating the secret information for use by device each time the information processing apparatus is connected to a device which is the same as or different from one to which the apparatus was connected last time.

Further features of the present invention will become apparent from the following description of exemplary embodiments with reference to the attached drawings.

### BRIEF DESCRIPTION OF THE DRAWINGS

FIG. 1 is a block diagram showing the hardware construction of a printer including an information processing apparatus according to a first embodiment of this invention;

FIG. 2 is a block diagram showing function blocks of the printer of the first embodiment;

FIG. 3 is a view showing the overall construction of the information processing system of the first embodiment;

FIGS. 4A and 4B are a flowchart of processing to update secret information;

FIGS. 5A and 5B are a flowchart of processing to execute printing; and

FIG. 6 is a view showing part of a flowchart of processing to update secret information according to a second embodiment of this invention.

### DETAILED DESCRIPTION OF THE PREFERRED EMBODIMENTS

The present invention will now be described in detail below with reference to the drawings showing preferred embodiments thereof.

Some device such as a printer or a multi-function peripheral is adapted to be connected (or mounted) with an expansion card, as information processing apparatus, for expansion of functions of the device. Such a device should operate with various expansion cards. However, some device such as a printer or a multi-function peripheral does not have a sufficient user interface. Under these circumstance, it is not preferable to request a user or a serviceman to change the firmware of the device in accordance with which expansion card is connected to the device, or request him to install an expansion card driver to a user's PC (personal computer) or the like. To permit the device to adapt to various expansion cards without the need of changing the firmware of the device, it is preferable that the device should access any expansion card connected to the device by the same method and information proper to each individual expansion card should be retained in the card.

In a system where secret information such as a secret key (hereinafter referred to as the “secret information”) is retained in an expansion card as described above, this invention permits only one of devices of the system which is connected with the expansion card to use the secret information, while preventing other devices from using the secret information.

In the following, as an expansion card which is an information processing apparatus, a network card called a network print server will be described by way of example. A function provided by the expansion card is not limitative of this invention.

### First Embodiment

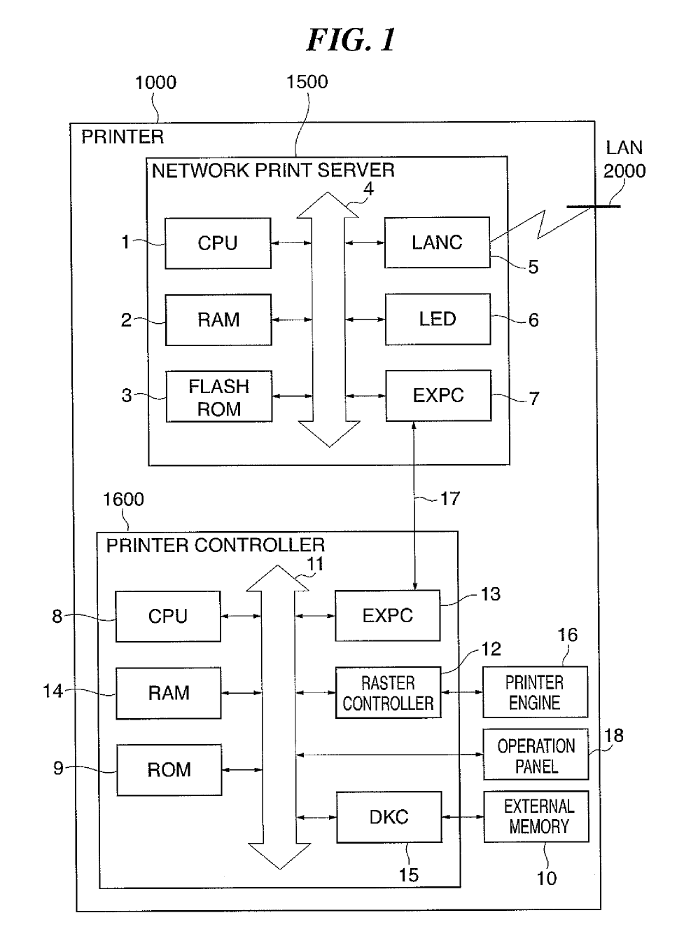

FIG. 1 shows in a block diagram the hardware structure of a printer including an information processing apparatus according to a first embodiment of this invention.

In this embodiment, a network print server 1500 as an information processing apparatus is detachably connected to a printer controller 1600 as a device. In an information processing system described in this embodiment, there are a plurality of printer controllers 1600 which are the same in construction from one another, and the network print server 1500 is capable of being connected to an arbitrary one of the printer controllers 1600. The printer controller 1600 connected with the network print server 1500 cooperates with the server 1500 to form a printer 1000. Thus, the printer 1000 is comprised of two pieces of equipment or two different control systems, i.e., the network print server 1500 and the printer controller 1600 to which the server 1500 is connected.

In the network print server 1500, a network print server CPU 1 operates in accordance with a control program stored in a rewritable flash ROM 3.

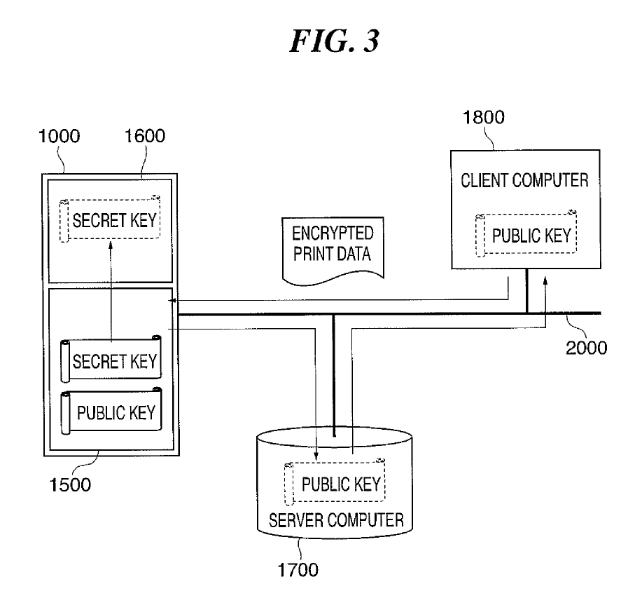

The CPU 1 is connected to a local area network (LAN) 2000 via a network controller (LANC) 5 connected to a system bus 4. Using a predetermined network communication protocol, the CPU 1 centrally controls print data and various data transfer/reception requests such as printer control instructions sent from external apparatuses such as a server computer 1700 and a client computer 1800 shown in FIG. 3. The CPU 1 carries out appropriate data transfer control for the printer controller 1600 connected thereto via an expansion interface controller (EXPC) 7 and a single-purpose expansion interface 17.

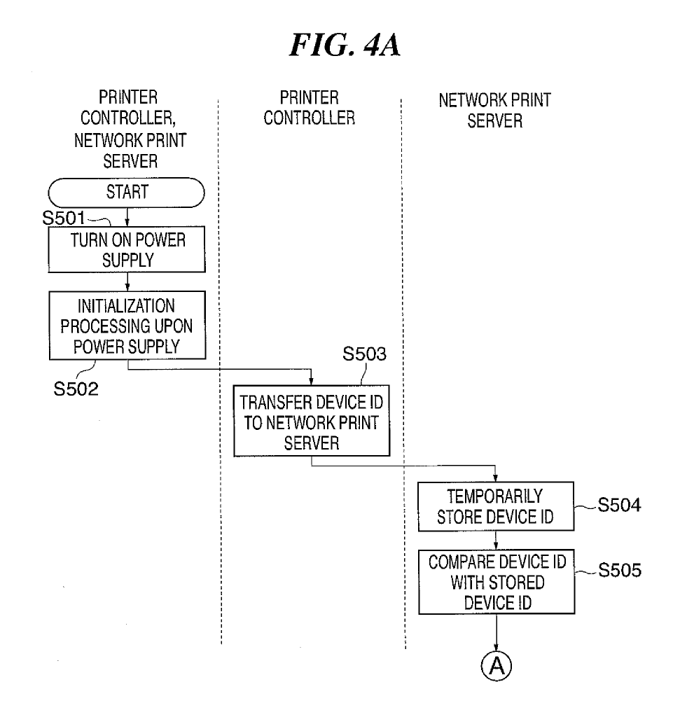

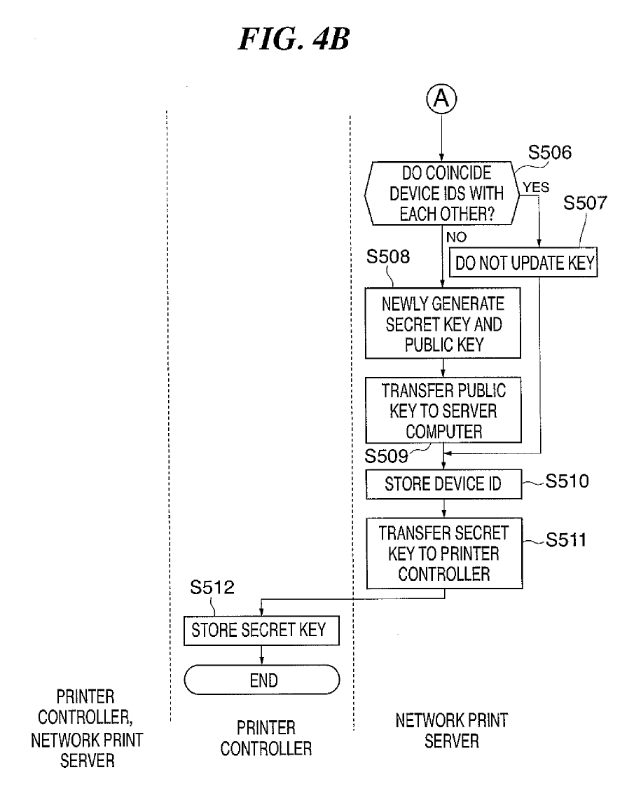

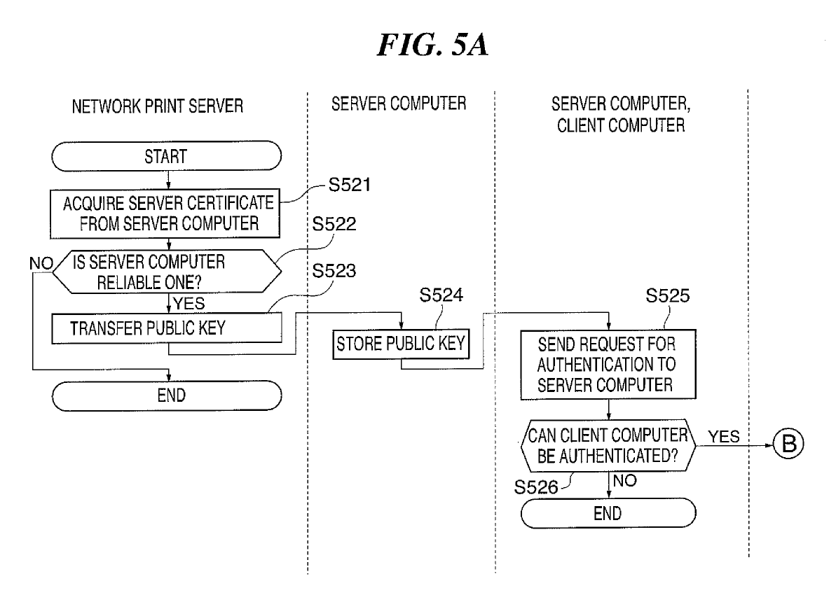

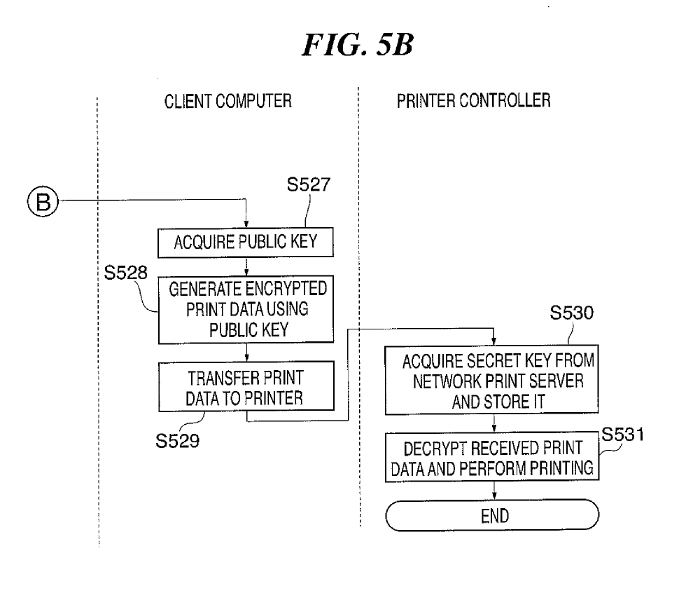

The flash ROM 3 stores a program (operating system) used for carrying out a part of processing of this invention shown in flowcharts of FIGS. 4A, 4B, 5A and 5B, a secret information generating function, and information of a secret key and a public key generated in the processing. A RAM 2 is used as a temporary storage area such as a main memory or work area for the CPU 1. An LED 6 is used as a display unit showing the operating state of the network print server 1500. For example, the LED 6 can indicate, by the flickering pattern or color of the LED, various operating states such as an electrical connection state (LINK) between the LANC 5 and the LAN 2000, and a network communication mode (10Base, 100Base, full-duplex, or half-duplex).

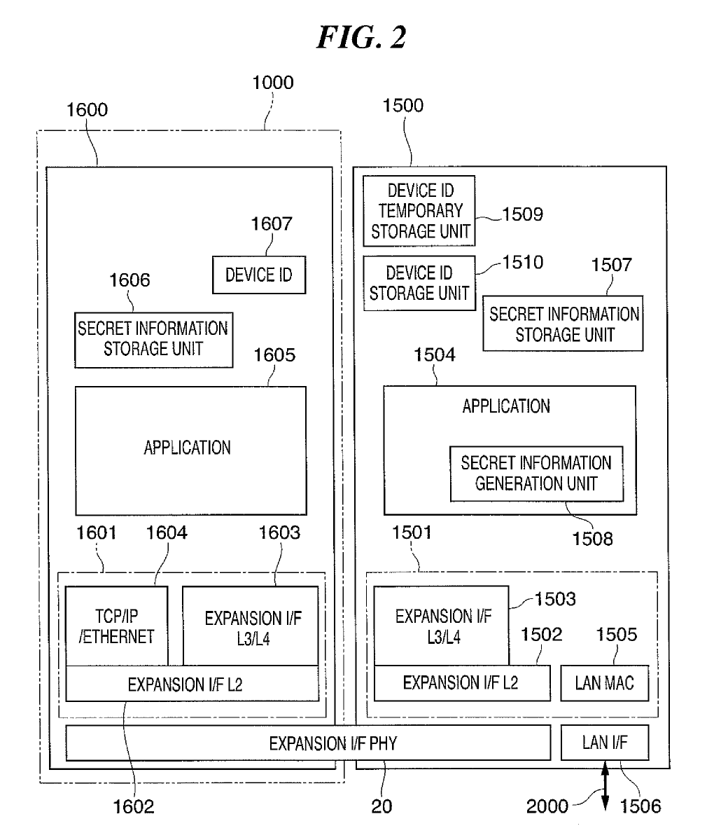

The expansion interface 17 through which the network print server 1500 is connected to the printer controller 1600 is comprised of a connector, not shown, and an expansion I/F Phy (physical layer) 20 described later with reference to FIG. 2. The expansion interface 17 is adapted to be detachably connected to the network print server 1500. Thus, the network printer server 1500 can be connected to another printer, other than the printer 1000 (printer controller 1600), having the same hardware construction as that of the printer 1000. In other words, with the construction of the expansion interface 17, various information processing apparatuses such as expansion cards having various functions, other than the network print server 1500, can be connected or connected to the printer 1000 (printer controller 1600).

In the printer controller 1600, there are a printer controller CPU 8, a ROM 9 in which control programs and resource data (resource information) are stored, and a disk controller (DKC) 15 to which is connected an external memory 10 stored with control programs, resource data, etc. The CPU 8 centrally controls accesses between the CPU and various devices connected to a system bus 11 in accordance with the control programs and resource data stored in the ROM 9 or the external memory 10.

The network print server 1500 is connected to the printer controller 1600 via an expansion interface controller (EXPC) 13 and the expansion interface 17. Based on print data received from the network print server 1500, the CPU 8 generates output image information using a raster controller 12 and outputs an image signal to a printer engine 16.

A RAM 14 functions as a main memory, a work area, etc. for the CPU 8. The memory capacity of the RAM 14 can be increased using an option RAM, not shown, adapted to be connected to an expansion port.

An operation panel 18 and the printer engine 16 are connected to the system bus 11. The operation panel 18 has buttons for, e.g., setting the operation mode of the printer 1000 and deleting print data, and a display unit such as a liquid crystal panel or LEDs showing the operating state of the printer 1000. The printer engine 16 utilizes an existing printing technique such as, for example, electrophotography (laser beam printing) ink-jet printing, and sublimatic printing (thermal transfer printing).

FIG. 2 shows in a block diagram the function blocks of the printer of this embodiment. In FIG. 2, function blocks of and software stored in memory devices of the network print server 1500 and the printer controller 1600 as control equipment are shown in the form of models. In the following, a model relating to the expansion interface 17 in particular will be described in detail.

The printer controller 1600 including the expansion I/F Phy 20 is physically connected to the network print server 1500. The printer controller 1600 includes an operating system 1601 having an expansion I/F L2 1602 and an expansion I/F L3/L4 1603. These expansion I/Fs respectively correspond to an expansion I/F L2 1502 and an expansion I/F L3/L4 1503 of an operating system 1501 of the network print server 1500.

The printer controller 1600 includes an application 1605, and the network print server 1500 includes an application 1504. Using the above-described expansion I/Fs 20, 1602, 1603, 1502 and 1503, data are transferred bi-directionally between the application 1605 and the application 1504.

The network print server 1500 includes a LAN I/F 1506, and the operating system 1501 includes a LAN Mac (Medium Access Controller) 1505. The operating system 1601 includes a TCP/IP/Ethernet (registered trademark) 1604. The TCP/IP/Ethernet (registered trademark) 1604 controls accesses to the LAN 2000, using the LAN Mac 1505 and the LAN I/F 1506 via the expansion I/F L2 1602 and the expansion I/F Phy 20. Thus, a user can access the application 1605 and the printer controller 1600 (printer 1000).

The application 1605 can communicate via the LAN 2000 with external apparatuses such as the server computer 1700 and the client computer 1800, described in detail later (see, FIG. 3).

The LAN Mac 1505 and the LAN I/F 1506 provide the functions of layer 2 and layer 1 of the local area network protocol, which are proper to the network print server 1500. For example, in a case where the network print server 1500 is comprised of a network print serer using wireless LAN (WLAN), the LAN Mac 1505 and the LAN I/F 1506 operate to realize the wireless LAN. On the other hand, in a case where the network print server 1500 is comprised of an expansion card not using LAN protocol, different function blocks are provided in the LAN Mac 1505 and the LAN I/F 1506.

The network print server 1500 includes a secret information storage unit (secret key/public key) 1507, which is secret information automatically generated and held in a secret information generation unit 1508. The secret information storage unit 1507 of the network print server 1500 is adapted to store a secret key and a public key, which are secret information automatically generated and held in the secret information generation unit 1508. The printer controller 1600 includes a secret information storage unit 1606 adapted to store the secret key.

The application 1605 acquires the secret key in the secret information storage unit 1507 from the network print server 1500. Specifically, the application acquires the secret key via the expansion I/Fs 20, 1602, 1603, 1502, 1503 and the application 1504. The acquired secret key is held in the secret information storage unit 1606. The secret information storage unit 1606 is provided in a nonvolatile memory device, not shown, so as to prevent information from being lost even if the power supply to the printer 1000 is turned off.

The printer controller 1600 includes a device ID 1607, which is identification information (hereinafter sometimes referred to as the “device ID”) used for uniquely identifying the printer controller 1600 and the printer 1000.

The device ID 1607 is provided in the printer 1000 (printer controller 1600) upon shipment thereof. By performing the below-described processing, the device ID 1607 is transferred from the printer controller 1600 to the network print server 1500, is temporarily stored in a device ID temporary storage unit 1509, and is then stored in a device ID storage unit 1510.

Both the device ID storage unit 1510 and the secret information storage unit 1507 are provided in the flash ROM 3, which is comprised of a nonvolatile memory device. On the other hand, the device ID temporary storage unit 1509 is provided in the RAM 2 (see, FIG. 1).

FIG. 3 shows the overall construction of the information processing system of this embodiment. This system is comprised of the printer 1000 and external apparatuses such as the server computer 1700, the client computer 1800, etc., which are connected to the printer via the LAN 2000. As described above, there can be provided a plurality of printer controllers 1600.

As will be described in detail in FIGS. 4A, 4B, 5A and 5B, a public key automatically generated in the network print server 1500 is transferred from the network print server 1500 to the server computer 1700, and the public key transferred to the server computer 1700 is acquired by the client computer 1800. The client computer 1800 encrypts print data using the acquired public key and transfers the encrypted print data to the network print server 1500. Then, the printer controller 1600 acquires from the network print server 1500 the secret key automatically generated by the network print server 1500. Using the acquired secret key, the printer controller 1600 decrypts the encrypted print data and executes print processing (predetermined function).

FIGS. 4A and 4B show a flowchart of processing to update secret information, and FIGS. 5A and 5B show a flowchart of processing to execute printing.

The processing of FIGS. 4A and 4B is performed in parallel by the CPUs 1 and 8 of the network print server 1500 and the printer controller 1600. The processing of FIGS. 5A and 5B is performed in parallel by the network print server 1500, the printer controller 1600, the server computer 1700, and the client computer 1800. Names of main constituents that perform various steps of the processing are shown in the uppermost parts of FIGS. 4A, 4B, 5A and 5B.

Control procedures for these steps are stored in the flash ROM 3 of the network print server 1500, the ROM 9 of the printer controller 1600 (see, FIG. 1), and memory devices, not shown, of the server computer 1700 and the client computer 1800.

Referring to FIGS. 4A and 4B, when power supply to the printer 1000 is turned on in step S501, electric power is supplied to the printer controller 1600 and the network print server 1500 connected thereto.

Next, in step S502, the printer controller 1600 carries out initialization processing upon power supply. For example, the work area of the RAM 14 is cleared, the printer engine 16 is initialized, and whether or not any abnormality is present in the printer 1000 is checked. Then, the printer controller 1600 carries out initialization for communication with the network print server 1500 via the expansion interface 17 and initialization for network communication via the LAN 2000.

In step S502, the network print server 1500 performs initialization processing upon power supply. For example, the network print server 1500 carries out initialization for communication with the printer controller 1600 via the expansion interface and initialization for permitting the printer controller 1600 to perform network communication via the LAN 2000.

In the initialization processing in step S502, in accordance with a method not shown, the printer controller 1600 determines whether or not any expansion card is connected to the expansion interface 17 of the printer controller 1600. If an expansion card is connected to the expansion interface 17, the printer controller 1600 further determines whether or not the connected expansion card is the network print server 1500. To this end, the printer controller 1600 acquires from the expansion card via the expansion interface 17 information indicating the function of the expansion card, for example. On the other hand, if no expansion card is connected to the expansion interface 17 or if the connected expansion card is not the network print server 1500, processing of step S503 and subsequent steps is not executed.

If it is determined in the initialization processing in step S502 that the network print server 1500 is connected to the printer controller 1600, the flow proceeds to step S503 where the printer controller 1600 transfers the stored device ID (device ID 1607 shown in FIG. 2) to the network print server 1500 via the expansion interface 17.

In the next step S504, the network print server 1500 receives the device ID transferred from the printer controller 1600, and temporarily stores the received device ID into the device ID temporary storage unit 1509. Next, the network print server 1500 compares the device ID stored in the device ID temporary storage unit 1509 with the device ID already saved in the device ID storage unit 1510 (steps S505 and S506).

With the comparison between these device IDs, the network print server 1500 can determine whether or not the printer controller 1600 to which the network print server 1500 is currently connected is the same as one to which the network print server 1500 was connected last time.

Although a detailed description is omitted here, upon shipment of the network print server 1500 from a factory, a value was stored in the device ID storage unit 1510 that does not coincide with any of device IDs of any other printer controllers. Such a value is comprised of digits all of which are either “0” or “1”, for example. Needless say, the value stored in the device ID storage unit 1510 can be initialized, using an initializing method not shown, to the same value as that stored upon shipment from the factory.

If it is determined in step S506 that the device IDs do not coincide with each other, this is a case where the print server 1500 is disconnected from the former printer controller to which it was connected last time and then connected to a different printer controller 1600 during stoppage of power supply, or a case where the network print server 1500 is connected to the printer controller 1600 for the first time after shipment thereof from a factory. On the other hand, if the device IDs coincide with each other, this is a case where the network print server 1500 remains connected to the same printer controller 1600 between this time and the last time.

Thus, when the device IDs coincide with each other, the network print server 1500 determines that it is unnecessary to update the key (step S507), and the flow proceeds to step S510. In that case, the secret information is not generated nor updated.

On the other hand, when the device IDs do not coincide with each other, the network print server 1500 causes the secret information generation unit 1508 to automatically generate new secret information (secret key and public key) and store them into the secret information storage unit 1507 (step S508). At this time, the existing secret information stored in the secret information storage unit 1507 is overwritten by the new secret information generated by the secret information generation unit 1508, whereby the new secret information is stored to thereby update the secret information.

As information used as a seed for generation of secret information (secret key and public key), there can be used the device ID transferred from the printer controller 1600. Alternatively, time information acquired from the printer controller 1600 can be used, provided that the acquired time information is not inappropriate one (such as one indicating some future year such as 2100 or some past year before 2006). Functions and advantages of this invention do not vary depending on a type of seed used for generation of secret information.

Next, the network print server 1500 transfers the public key of the secret information generated in step S508 to the server computer 1700 (see FIG. 3) connected to the LAN 2000 (step S509). Processing to actually transfer the public key and store it in the server computer 1700 is implemented in steps S521 to S524 of FIG. 5A described later. Specifically, the processing of FIGS. 5A and 5B is started from step S521 in the processing of step S509.

In the next step S510, the network print server 1500 causes the device ID storage unit 1510 to store the device ID currently stored in the device ID temporary storage unit 1509. As a result, the device ID stored in the device ID storage unit 1510 at the present time is updated to the device ID acquired from the printer controller 1600 to which the network print server 1500 is currently connected. The timing in which the processing to update the device ID in the device ID storage unit 1510 is carried out is not limited to the above-mentioned timing. Specifically, the device ID can be updated in any timing after the comparison between the device IDs is completed and before the network print server 1500 is disconnected from the printer controller 1600 to which the network print server 1500 is currently connected.

Next, the network print server 1500 transfers the secret key of the secret information generated in step S508 to the printer controller 1600 (step S511). The printer controller 1600 causes the secret information storage unit 1606 to store the secret key transferred from the network print server 1500 (step S512). The secret key can be transferred after a request for acquisition of the secret key is issued from the printer controller 1600 (steps S529 and S530 of FIG. 5B described below).

The action of reading the secret key out from the network print server 1500 and transferring it to the printer controller 1600 appears to cause some trouble from the viewpoint of security. However, the printer controller 1600 and the network print server 1500 in this invention are connected to each other by the single-purpose expansion interface 17, and therefore, the secret key cannot be stolen except when an ill-intentioned third party analyzes the expansion interface 17 and prepares the same interface. Thus, there is a low possibility of occurrence of security problems.

Next, with reference to a flowchart of FIGS. 5A and 5B, an explanation will be given of the process of the public key being transferred to the server computer 1700 and the flow of print data being encrypted by the client computer 1800 using the public key and the encrypted print data being transferred for printing to the printer 1000.

First, in step S521, the network print server 1500 performs authentication of the server computer 1700 prior to transfer of a copy of the public key stored in the secret information storage unit 1507 to the server computer 1700, to thereby determine whether or not the server computer 1700 is a reliable (or intended) server computer. To this end, the network print server 1500 acquires a server certificate, not shown, from the server computer 1700, and then determines, using the acquired server certificate, whether or not the server computer 1700 is a reliable one (step S522). If it is determined that the server computer 1700 is not reliable, the present processing is terminated.

On the other hand, it is determined that the server computer 1700 is reliable, the network print server 1500 transfers a copy of the public key stored in the secret information storage unit 1507 to the server computer 1700 (step S523). After receiving the copy of the public key, the server computer 1700 stores the public key into a nonvolatile memory device, not shown (step S524).

In order for the client computer 1800 to perform secure printing (or safely transfer print data to the printer 1000), the public key used to encrypt the print data is required. Since the public key has been generated by the network print server 1500 and then transferred to the server computer 1700, the client computer 1800 is required to acquire the public key from the server computer 1700.

To permit the client computer 1800 to perform secure printing, the processing of FIGS. 5A and 5B is started from step S525. The client computer 1800 first sends a request for authentication to the server computer 1700, thereby requesting the server computer 1700 to perform authentication of the client computer 1800 (step S525). In accordance with the request for authentication, the server computer 1700 authenticates the client computer 1800 and determines whether or not the client computer 1800 can be authenticated (step S526). If the client computer 1800 cannot be authenticated, the present process is terminated. On the other hand, if the client computer 1800 can be authenticated, the client computer 1800 acquires the public key from the server computer 1700 (steps S526 and S527).

When the public key is acquired in step S527, the computer 1800 uses the public key to encrypt print data to be used for printing (step S528), and transfers the encrypted print data to the printer 1000 (step S529). As a result, the encrypted print data is provided to the printer controller 1600 via the network print server 1500.

When receiving the encrypted print data from the client computer 1800, the printer controller 1600 acquires the secret key from the network print server 1500 and stores the secret key into the secret information storage unit 1606 (step S530). The secret key has been generated by the network print server 1500 in step S508 in FIG. 4B. Next, using the stored secret key, the printer 1000 (printer controller 1600) decrypts the encrypted print data, and performs printing based on the decrypted print data (step S531).

It should be noted that the processing to immediately transfer the generated secret key to the printer controller 1600 (steps S511 and S512) can be eliminated. In that case, the secret key can be transferred only by the processing in step S530, and the secret key is transferred after a request for printing is issued from the client computer 1800.

According to this embodiment, in a state where the network print server 1500 is connected to the printer controller 1600, the network print server 1500 generates secret information and stores the secret information into the secret information storage unit 1507, whereby the secret information is updated. The secret information is generated and updated each time the network print server 1500 is connected to (used by) the printer controller 1600. As a result, the printer controller 1600 can refer to (acquire) the secret information only in a state where the network print server 1500 is connected to the printer controller 1600. In addition, the secret information is substantially proper to the printer controller 1600 to which the network print server 1500 is currently connected. In other words, the secret information is automatically changed depending on the printer controller 1600 to which the network print server 1500 is connected.

If the network print server 1500 disconnected from the printer controller 1600 is connected to another printer controller 1600, the old secret information remains in the former printer controller 1600 from which the network print server 1500 has been disconnected. However, the former printer controller 1600 cannot print encrypted data using the old secret information, resulting in improved security of encrypted data in a transmission path along which the encrypted data is transmitted from the client computer to the printer controller 1600. Furthermore, the probability of leakage of information (encrypted data) due to erroneous operation can be lowered, so that secret information leakage can substantially be suppressed.

The secret information is updated each time the network print server 1500 is connected to (used by) the printer controller 1600, thereby capable of suppressing the secret information from being leaked and unauthorizedly used.

In this embodiment, the network print server 1500 determines whether or not the device ID stored in the device ID temporary storage unit 1509 coincides with the device ID already saved in the device ID storage unit 1510, and newly generates secret information only when these device IDs do not coincide with each other. This makes it possible to disable processing, in which is used old secret information still remaining in the former printer controller 1600 to which the network print server 1500 was connected last time. In addition, whether or not the device to which the network print server 1500 is currently connected differs from the former device to which it was connected last time can be determined, and the secret information can be updated only when required, thereby capable of eliminating wasteful processing.

### Second Embodiment

In the first embodiment, secret information is not generated if the device ID stored in the device ID temporary storage unit 1509 coincides with the device ID already saved in the device ID storage unit 1510 (step S507 in FIG. 4B).

On the other hand, in the second embodiment of this invention, secret information is generated when there is a request from the printer controller 1600, even if these device IDs coincide with each other.

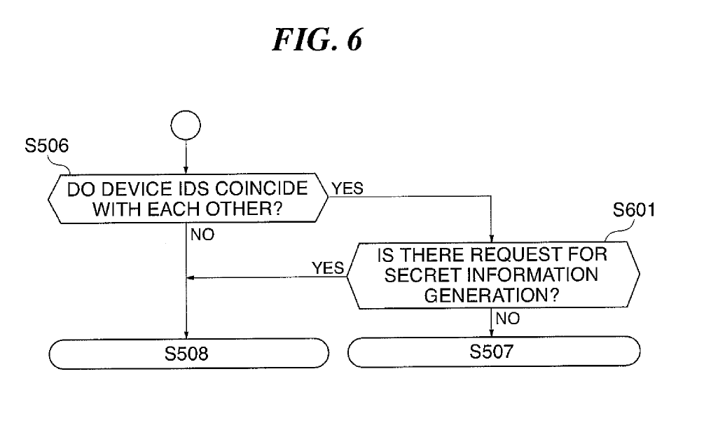

FIG. 6 shows a part of processing to update secret information in this embodiment, which includes additional step S601 to be added to the processing shown in FIG. 4B.

Specifically, if it is determined in step S506 that the above-described device IDs coincide with each other, the network print server 1500 determines whether or not there is a request for secret information generation from the printer controller 1600 to which the network print server 1500 is currently connected (step S601). If it is determined that there is no request for secret information generation, the flow proceeds to step S507. On the other hand, there is a request for secret information generation, the flow proceeds to step S508 where processing is performed to automatically generate secret information (secret key and public key) and store the automatically generated secret information into the secret information storage unit 1507.

A request for secret information generation is issued in the printer controller 1600 in accordance with a user's instruction. Alternatively, such a request can be issued each time a request for printing is issued from the client computer 1800.

According to this embodiment, the processing can be carried out based on the latest secret information to thereby improve the security, in addition to realizing advantages which are the same as or similar to the advantages attained by the first embodiment.

In each of the above described embodiments, the network print server 1500 is connected to the printer 1000 via the expansion interface 17, but this is not limitative. For example, the network print server 1500 or some other expansion card can be connected via the expansion interface 17 to a multi-function peripheral called a multi-function printer (which is commonly known as the “MFP”) and having both the functions of copier and facsimile. The present invention can be applied to such an arrangement and can achieve advantages similar to those attained by the embodiments.

In the above described embodiments, the printer controller 1600 as a device and the print processing function as a predetermining function have been described by way of example, but these are not limitative. For example, the present invention can be applied to any device having various functions of copier, facsimile, file conversion, screen display, etc., and can be applied to these functional processing.

It is to be understood that the present invention may also be accomplished by supplying a system or an apparatus with a storage medium in which a program code of software, which realizes the functions of the above described embodiments is stored and by causing a computer (or CPU or MPU) of the system or apparatus to read out and execute the program code stored in the storage medium.

In that case, the program code itself read from the storage medium realizes the functions of the above described embodiments, and therefore the program code and the storage medium in which the program code is stored constitute the present invention.

Examples of the storage medium for supplying the program code include a floppy (registered trademark) disk, a hard disk, and a magnetic-optical disk, an optical disk such as a CD-ROM, a CD-R, a CD-RW, a DVD-ROM, a DVD-RAM, a DVD-RW, a DVD+RW, a magnetic tape, a nonvolatile memory card, and a ROM. The program code may be downloaded via a network.

Further, it is to be understood that the functions of the above described embodiments may be accomplished not only by executing the program code read out by a computer, but also by causing an OS (operating system) or the like which operates on the computer to perform a part or all of the actual operations based on instructions of the program code.

Further, it is to be understood that the functions of the above described embodiments may be accomplished by writing a program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-339068, filed Dec. 15, 2006, which is hereby incorporated by reference herein in its entirety.

What is claimed is:

1. An information processing apparatus adapted to be connected to a device, comprising:
a storage unit adapted to store secret information;
a secret information generation unit adapted to generate another secret information when the information processing apparatus is connected to the device;
a secret information update unit adapted to update the secret information stored in said storage unit to the other secret information generated by said secret information generation unit in a case where the secret information is generated by said secret information generation unit; and
a secret information transfer unit adapted to transfer the other secret information updated by said secret information update unit and stored in said storage unit to the device to which said information processing apparatus is connected.

2. The information processing apparatus according to claim 1, further comprising:
a first identification information acquisition unit adapted to acquire identification information from the device in a state that the information processing apparatus is connected to the device;
a memory unit adapted to store the identification information acquired by said first identification information acquisition unit;
a second identification information acquisition unit adapted to acquire identification information used to uniquely identify the device from the device when the information processing apparatus is connected to the device; and
a determination unit adapted to determine whether or not the identification information acquired by said second identification information acquisition unit coincides with the identification information stored in said memory unit,
wherein said secret information generation unit determines whether or not the other secret information is to be generated in accordance with a result of determination by said determination unit.

3. The information processing apparatus according to claim 2, wherein said secret information generation unit generates the other secret information when it is determined by said determination unit that the identification information acquired by said second identification information acquisition unit does not coincide with the identification information stored in said memory unit, but does not generate the other secret information when it is determined by said determination unit that the acquired identification information coincides with the stored identification information.

4. The information processing apparatus according to claim 3, wherein said secret information generation unit generates the other secret information when there is a request from the device to which said information processing apparatus is connected, even if it is determined by said determination unit that the identification information acquired by said second identification information acquisition unit coincides with the identification information stored in said memory unit.

5. A device to which the information processing apparatus as set forth in claim 1 is connected, comprising:
a secret information acquisition unit adapted to acquire the other secret information transferred from said secret information transfer unit of the connected information processing apparatus; and
a processing unit adapted to decode received data using the other secret information acquired by said secret information acquisition unit.

6. An information processing system including a plurality of devices and an information processing apparatus adapted to be connected to an arbitrary one of said plurality of devices, wherein said information processing apparatus comprises:
a storage unit adapted to store secret information;
a secret information generation unit adapted to generate another secret information when the information processing apparatus is connected to the device;
a secret information update unit adapted to update the secret information stored in said storage unit to the other secret information generated by said secret information generation unit in case where the secret information is generated by said secret information generation unit; and
a secret information transfer unit adapted to transfer the other secret information updated by said secret information update unit and stored in said storage unit to the device to which said information processing apparatus is connected, and
wherein each of said plurality of devices comprises:
a secret information acquisition unit adapted to acquire the other secret information transferred from said secret information transfer unit; and
a processing unit adapted to decode received data using the other secret information acquired by said secret information acquisition unit.

7. An information processing program that causes a computer to execute an information processing method in an information processing apparatus including a storage unit adapted to store secret information, said information processing method comprising:
a secret information generation step of generating another secret information, with said information processing apparatus connected to a device;
a secret information update step of updating the secret information stored in the storage unit to the other secret information generated in said secret information generation step in case where the other secret information is generated in said secret information generation step; and
a secret information transfer step of transferring the other secret information updated in said secret information update step and stored in the storage unit to the device to which the information processing apparatus is connected.

8. A storage medium in which the information processing program as set forth in claim 7 is computer-readably stored.
